(19) United States
(12) Patent Application Publication
(10) Pub. No.: US 2016/0353774 A1
(43) Pub. Date: Dec. 8, 2016

(54) NUTRITIONAL COMPOSITIONS COMPRISING SPORE-FORMING PROBIOTICS

(71) Applicant: Mead Johnson Nutrition Company, Glenview, IL (US)

(72) Inventor: Juan M. Gonzalez, Newburgh, IN (US)

(21) Appl. No.: 14/727,978

(22) Filed: Jun. 2, 2015

(51) Int. Cl. A23L 1/29; A23L 1/305; A23L 1/308; A23L 1/30

(52) U.S. Cl. CPC A23L 1/296; A23L 1/30; A23L 1/305; A23L 1/3014; A23L 1/3088; A23L 1/3008; A23V 2002/00

(57) ABSTRACT

Disclosed are nutritional compositions for pediatric subjects, such as children's nutritional products and infant formulas, which include a protein or protein equivalent source, a fat, a carbohydrate, and a spore-forming probiotic.

### BACKGROUND

Technical Field

The present disclosure relates to nutritional compositions comprising a spore-forming probiotic. The nutritional compositions are suitable for administration to pediatric subjects. Additionally, the disclosure relates to methods of delivering nutritional compositions that contain probiotics to pediatric subjects for management of diarrhea, prevention or reduction of allergic skin conditions, and enhancement of the immune function.

Background Art

The gut microflora of infants is less developed than that of adults. While the microflora of the adult human consists of more than 10¹³ microorganisms and nearly 500 species, the gut microflora of an infant contains only a fraction of those microorganisms, both in absolute number and species diversity. Because the bacterial populations and species vary immensely between the gut of an infant or child and an adult, it cannot be assumed that a prebiotic substance that has a beneficial effect on adults would also have a beneficial effect on infants and/or children.

There are currently a variety of compositions for supplementing the gastrointestinal tracts of both humans and animals. These supplements may be provided to alter, reduce or increase the microflora within the individual's gut so as to cause a desired effect on digestion. Ideally, supplementation may cultivate an improved microflora for individuals, including humans, based upon the alteration of specific bacteria within the human's gastrointestinal (GI) tract. This style of supplementation may be conducted through the use of probiotics which are understood to be live microorganisms, that when administered in effective amounts, confer a health or nutritional benefit to the host. One of the more common types of probiotics is a lactic acid bacterium such as Lactobacillus rhamnosus GG (LGG).

A common challenge in producing nutritional formulas with probiotics like LGG is sustaining the viability of the LGG in varying heat conditions. LGG's vegetative cells are temperature sensitive. Accordingly, the LGG can experience a level of degradation in viability during shipment or heating that decreases its ability to perform its function by the time it is administered to a subject. The traditional distribution channel for powder infant formulas does not involve refrigerated transportation. Notably, powder products may be exposed to temperatures as high as 60° C. to 70° C. during shipping. Shipping and shelf life stability studies of infant formulas containing LGG have also shown significant decreases in viable cell counts to levels below those recommended for efficacy.

Current technologies for addressing heat-mediated degradation of probiotics include the utilization of encapsulation and stabilization techniques for shielding the probiotics with a protective layer or matrix so that the microbe may pass to the appropriate location within the individual's GI tract. See Rangavajla et al. (U.S. Patent Application No. 2011/0070334). Bacteria and enzymes can be successfully encapsulated in either alginate microcapsules or cellulose acetate phthalate microspheres. Through encapsulation, viability is sustained for the bacteria and enzymes so that the encapsulated cells reach the appropriate gastric region of the subject.

What is desired, however, is a nutritional composition using acceptable ingredients for either an infant formula or children's nutritional products. What is further desired is a nutritional composition allowing for improved stability properties so that probiotics may be distributed in a wide variety of geographical locations and climates. What is still further required is a nutritional composition that will maintain a useful shelf-life without the need for encapsulation or similar technologies. Indeed, this combination of characteristics, including improved stability combined with nutritional factors, is desired to provide a stabilization mixture applicable for prenatal, infant, and children's nutrition.

Accordingly, it would be beneficial to provide a nutritional composition for pediatric subjects comprising a substance that manages diarrhea, reduced skin allergies, and stimulates the immune system, wherein the substance maintains stability in varying temperature conditions.

### BRIEF SUMMARY

Briefly, the present disclosure is directed, in an embodiment, to a nutritional composition comprising a fat or lipid, a protein source, a carbohydrate, and a spore-forming probiotic. In certain embodiments, the nutritional composition further includes a source of long chain polyunsaturated fatty acids which include docosahexaenoic acid (DHA) and/or a prebiotic composition which includes a plurality of oligosaccharides. In certain embodiments, the prebiotic comprises a combination of a galacto-oligosaccharide and polydextrose.

The disclosure is also directed to a nutritional composition comprising, in some embodiments:
a. up to about 7 g/100 kcal of a fat or lipid, more preferably about 3 to about 7 g/100 kcal of a fat or lipid;
b. up to about 5 g/100 kcal of a protein or protein equivalent source, more preferably about 1 to about 5 g/100 kcal of a protein or protein equivalent source;
c. about 5 to about 100 mg/100 kcal of a source of long chain polyunsaturated fatty acids which include DHA, more preferably about 10 to about 50 mg/100 kcal of a source of long chain polyunsaturated fatty acids which include DHA;
d. about 1.0 to about 10.0 g/100 kcal, more preferably about 2.0 g/100 kcal to about 8.0 g/100 kcal, of a prebiotic composition comprising a plurality of oligosaccharides; and
e. a spore-forming probiotic.

In yet another embodiment, the disclosure is directed to a nutritional composition having improved digestibility, the composition comprising a lipid or fat, a protein source, a source of long chain polyunsaturated fatty acids which include docosahexaenoic acid (DHA), a prebiotic composition which comprises at least 20% of an oligosaccharide mixture comprising polydextrose and galacto-oligosaccharides, and the spore-forming probiotic Bacillus coagulans.

It is to be understood that both the foregoing general description and the following detailed description present embodiments of the disclosure and are intended to provide an overview or framework for understanding the nature and character of the disclosure as it is claimed. The description serves to explain the principles and operations of the claimed subject matter. Other and further features and advantages of the present disclosure will be readily apparent to those skilled in the art upon a reading of the following disclosure.

### DETAILED DESCRIPTION

Reference now will be made in detail to the embodiments of the present disclosure, one or more examples of which are set forth herein below. Each example is provided by way of explanation of the nutritional composition of the present disclosure and is not a limitation. In fact, it will be apparent to those skilled in the art that various modifications and variations can be made to the teachings of the present disclosure without departing from the scope or spirit of the disclosure. For instance, features illustrated or described as part of one embodiment, can be used with another embodiment to yield a still further embodiment.

Thus, it is intended that the present disclosure covers such modifications and variations as come within the scope of the appended claims and their equivalents. Other objects, features and aspects of the present disclosure are disclosed in or are obvious from the following detailed description. It is to be understood by one of ordinary skill in the art that the present discussion is a description of exemplary embodiments only and is not intended as limiting the broader aspects of the present disclosure.

The present disclosure relates to nutritional compositions comprising a spore-forming probiotic. In some embodiments, the spore-forming probiotic may comprise Bacillus coagulans. Also, in embodiments, the probiotic may comprise additional beneficial bacteria.

When administered to individuals, the nutritional composition including the probiotic, prebiotic, and LCPUFA has advantageous effects on management of diarrhea, allergic skin conditions, and enhanced immune function. For example, in some embodiments, the nutritional composition can reduce infantile rotavirus diarrhea. In certain embodiments, the nutritional composition can reduce jaundice.

“Nutritional composition” means a substance or formulation that satisfies at least a portion of a subject's nutrient requirements.

“Pediatric subject” means a human that is less than 13 years of age. In some embodiments, a pediatric subject refers to a human subject that is less than 8 years old.

“Infant” means a subject ranging in age from birth to not more than about one year and includes infants from 0 to about 12 months corrected age. The term infant includes low birth weight infants, very low birth weight infants, and preterm infants. The phrase “corrected age” means an infant's chronological age minus the amount of time that the infant was born premature. Therefore, the corrected age is the age of the infant if it had been carried to full term.

“Child” means a subject ranging in age from about 12 months to about 13 years. In some embodiments, a child is a subject between the ages of one and twelve years old. In other embodiments, the terms “children” or “child” refer to subjects that are two, three, four, five or six years old. In other embodiments, the terms “children” or “child” refer to any range of ages between about 12 months and about 13 years.

“Children's nutritional product” refers to a composition that satisfies at least a portion of the nutrient requirements of a child. A growing-up milk is an example of a children's nutritional product.

“Infant formula” means a composition that satisfies at least a portion of the nutrient requirements of an infant. In the United States, the content of an infant formula is dictated by the federal regulations set forth at 21 C.F.R. Sections 100, 106, and 107. These regulations define macronutrient, vitamin, mineral, and other ingredient levels in an effort to stimulate the nutritional and other properties of human breast milk.

The term “growing-up milk” refers to a broad category of nutritional compositions intended to be used as a part of a diverse diet in order to support the normal growth and development of a child between the ages of about 1 and about 6 years of age.

The term “degree of hydrolysis” refers to the extent to which peptide bonds are broken by a hydrolysis method. The degree of protein hydrolysis for purposes of characterizing the hydrolyzed protein component of the nutritional composition is easily determined by one of ordinary skill in the formulation arts by quantifying the amino nitrogen to total nitrogen ratio (AN/TN) of the protein component of the selected formulation. The amino nitrogen component is quantified by USP titration methods for determining amino nitrogen content, while the total nitrogen component is determined by the Tecator Kjeldahl method, all of which are well known methods to one of ordinary skill in the analytical chemistry art.

The term “partially hydrolyzed” means having a degree of hydrolysis which is greater than 0% but less than about 50%.

The term “extensively hydrolyzed” means having a degree of hydrolysis which is greater than or equal to about 50%.

The term “protein-free” means containing no measurable amount of protein, as measured by standard protein detection methods such as sodium dodecyl (lauryl) sulfate-polyacrylamide gel electrophoresis (SDS-PAGE) or size exclusion chromatography. In some embodiments, the nutritional composition is substantially free of protein, wherein “substantially free” is defined hereinbelow.

“Nutritionally complete” means a composition that may be used as the sole source of nutrition, which would supply essentially all of the required daily amounts of vitamins, minerals, and/or trace elements in combination with proteins, carbohydrates, and lipids. Therefore, a nutritional composition that is “nutritionally complete” for a preterm infant will, by definition, provide qualitatively and quantitatively adequate amounts of carbohydrates, lipids, essential fatty acids, proteins, essential amino acids, conditionally essential amino acids, vitamins, minerals, and energy required for growth of the preterm infant. A nutritional composition that is “nutritionally complete” for a full term infant will, by definition, provide qualitatively and quantitatively adequate amounts of all carbohydrates, lipids, essential fatty acids, proteins, essential amino acids, conditionally essential amino acids, vitamins, minerals, and energy required for growth of the full term infant.

A nutritional composition that is “nutritionally complete” for a child will, by definition, provide qualitatively and quantitatively adequate amounts of all carbohydrates, lipids, essential fatty acids, proteins, essential amino acids, conditionally essential amino acids, vitamins, minerals, and energy required for growth of a child.

“Probiotic” means a microorganism with low or no pathogenicity that exerts beneficial effects on the health of the host.

“Prebiotic” means a non-digestible food ingredient that beneficially affects the host by selectively stimulating the growth and/or activity of one or a limited number of bacteria in the digestive tract that can improve the health of the host. Such health benefits may include, but are not limited to, selective stimulation of the growth and/or activity of one or a limited number of beneficial gut bacteria, stimulation of the growth and/or activity of ingested probiotic microorganisms, selective reduction in gut pathogens, and favorable influence on gut short chain fatty acid profile.

“Effective amount” means an amount that provides a stimulatory immune effect in the subject.

The term “enteral” means deliverable through or within the gastrointestinal, or digestive, tract. “Enteral administration” includes oral feeding, intragastric feeding, transpyloric administration, or any other administration into the digestive tract. “Administration” is broader than “enteral administration” and includes parenteral administration or any other route of administration by which a substance is taken into a subject's body.

The term “spore” means a primitive usually unicellular reproductive body produced by plants, fungi, and some microorganisms and capable of development into a new individual either directly or after fusion with another spore. More specifically, a spore is a unit of asexual reproduction that may be adapted for dispersal and for survival, often for extended periods of time, in unfavorable conditions. Spores form part of the life cycles of many plants, algae, fungi and protozoa. Bacterial spores are not part of a sexual cycle but are resistant structures used for survival under unfavorable conditions.

The term “spore-forming” means capable of forming spores.

All percentages, parts and ratios as used herein are by weight of the total formulation, unless otherwise specified.

The nutritional composition of the present disclosure may be substantially free of any optional or selected ingredients described herein, provided that the remaining nutritional composition still contains all of the required ingredients or features described herein. In this context, and unless otherwise specified, the term “substantially free” means that the selected composition may contain less than a functional amount of the optional ingredient, typically less than 0.1% by weight, and also, including zero percent by weight of such optional or selected ingredient.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods and compositions of the present disclosure, including components thereof, can comprise, consist of, or consist essentially of the essential elements and limitations of the embodiments described herein, as well as any additional or optional ingredients, components or limitations described herein or otherwise useful in nutritional compositions.

As used herein, the term “about” should be construed to refer to both of the numbers specified in any range. Any reference to a range should be considered as providing support for any subset within that range.

In some embodiments, the selected ingredients for incorporation in the nutritional supplement may be from a suitable non-human organism. Indeed, the selected ingredients disclosed herein may be synthetically produced, purified, modified, and/or fortified by well-known methods. Indeed, ingredients and additives incorporated into the nutritional supplement may be man-made and possess certain characteristics not observed in naturally occurring substances. In some embodiments, the ingredients and nutrients disclosed herein may possess certain physical and/or chemical characteristics distinct from any naturally occurring substance.

The present disclosure describes a nutritional composition for a subject comprising a carbohydrate, a fat or lipid, a protein source and spore-forming probiotic, such as Baccillus coagulans. The disclosed nutritional composition may be provided in any form known in the art, such as a powder, a gel, a suspension, a paste, a solid, a liquid, a liquid concentrate, reconstitutable powdered milk substitute, or a ready-to-use product. The nutritional composition may, in certain embodiments, comprise a nutritional supplement, children's nutritional product, infant formula, human milk fortifier, growing up milk or any other nutritional composition designed for a pediatric subject. Nutritional compositions of the present disclosure include, for example, orally-ingestible, health-promoting substances including, for example, chewable foods, beverages, tablets, capsules and powders. The nutritional composition of the present disclosure may be standardized to a specific caloric content, it may be provided as a ready-to-use product, or it may be provided in a concentrated form.

The present disclosure also describes a method of enhancing the immune function of a pediatric subject comprising administering an effective amount of a nutritional composition comprising a carbohydrate source, a lipid source, a protein source and a spore-forming probiotic.

As noted, the disclosed nutritional composition includes a spore-forming probiotic; in some embodiments, the spore-forming probiotic comprises Bacillus coagulans. Bacillus coagulans is a gram positive, spore-forming, lactic acid producing microorganism with probiotic properties. B. coagulans can be isolated from healthy human intestinal flora. It is described in European Pat. No. 2,643,452 to Wang, et al., which is herein incorporated in its entirety, by reference. B. coagulans is resistant to many antibiotics, stable in the presence of acid and bile, and attaches avidly to mucosal cells of the human intestinal tract. It survives for 1-3 days in most individuals and up to 7 days in 30% of subjects. In addition to its colonization ability, B. coagulans also beneficially affects mucosal immune responses. B. coagulans is deposited with the depository authority American Type Culture Collection under accession numbers ATCC PTA-6085, ATCC PTA-6086, and ATCC PTA-6087.

The spore-forming property of B. coagulans provides a thermal advantage for nutritional product development applications over traditional probiotics, such as Lactobacilli and Bifidobacterium. The standard conditions of heat exposure during transportation and preparation (temperatures as high as 60° C. to 70° C.) would not be sufficient to inactivate B. coagulans spores in the disclosed nutritional compositions.

The spores of B. coagulans resist temperature fluctuations through transportation and heat abuse of composition reconstitution from powder and as such would be delivered intact into the stomach of a subject fed the compositions, such as an infant or other pediatric subject. The spores of B. coagulans also retain viability in the stomach acid environment. It is there that spore germination would be induced under the condition of humidity and body temperature. Vegetative cells would be slowly released into the intestine and there they would produce lactic acid, among other soluble excreted mediators, following a similar path as other probiotics.

B. coagulans microorganisms can be cultivated using processes conventional in the art. The B. coagulans can be used in its cultivated state or it may be processed as desired by purifying, concentrating or finishing it to produce various preparations.

The amount of spore-forming probiotic, such as B. coagulans, in the nutritional composition of the present disclosure is an amount sufficient to provide or deliver the desired probiotic effect. A sufficient amount may vary within a broad range, depending on, for example, the total amount of cells of probiotic, the total daily amount desired, and on other properties and ingredients of the product. For instance, the nutritional composiiton of the present disclosure can comprise about 10⁶ to 10¹² colony forming units (cfu) of spore-forming probiotic per 100 kcal of the composition. In another embodiment, the nutritional composition of the present disclosure can comprise about 10⁷ to 10¹⁰ cfu of B. coagulans per 100 kcal. In yet another embodiment, nutritional composition can comprise about 10⁸ to 10¹¹ cfu of B. coagulans per 100 kcal.

In one embodiment, the viability of the spore-forming probiotic is maintained in the nutritional composition of the present disclosure such that at least 10⁶ cfu/g probiotic per 100 kcal nutritional composition remains viable for a period of at least about 15 months. In another embodiment, the at least 10⁶ cfu/g of the spore-forming probiotic (e.g., B. coagulans) per 100 kcal remains viable for a period of at least about 19 months. In yet another embodiment, at least 10⁶ cfu/g of the probiotic remains viable for a period of at least about 22 months.

With the extended shelf-life provided by the present disclosure, it is not necessary to add chemical preservatives to the nutritional formulation or lyophilize, encapsulate, or provide a matrix for the probiotic in order to preserve its viability. Also, due to the extended shelf-life provided by the present disclosure, the disclosed nutritional composition does not require constant refrigeration or freezing, and is thus suitable for shipping and distribution even to tropical climates. As such, the composition can be provided in larger, more convenient or cost-effective quantities, as the viability of the organisms will be maintained for longer periods of time.

Suitable fat or lipid sources for inclusion in the composition of the present disclosure may be any known or used in the art, including but not limited to, animal sources, e.g., milk fat, butter, butter fat, egg yolk lipid; marine sources, such as fish oils, marine oils, single cell oils; vegetable and plant oils, such as corn oil, canola oil, sunflower oil, soybean oil, palmolein, coconut oil, high oleic sunflower oil, evening primrose oil, rapeseed oil, olive oil, flaxseed (linseed) oil, cottonseed oil, high oleic safflower oil, palm stearin, palm kernel oil, wheat germ oil; medium chain triglyceride oils and emulsions and esters of fatty acids; and any combinations thereof.

In some embodiments the nutritional composition may include an enriched lipid fraction derived from milk. The enriched lipid fraction derived from milk may be produced by any number of fractionation techniques. These techniques include but are not limited to melting point fractionation, organic solvent fractionation, super critical fluid fractionation, and any variants and combinations thereof. In some embodiments the nutritional composition may include an enriched lipid fraction derived from milk that contains milk fat globules.

In certain embodiments, the addition of the enriched lipid fraction or the enriched lipid fraction including milk fat globules may provide a source of saturated fatty acids, trans-fatty acids, monounsaturated fatty acids, polyunsaturated fatty acids, branched chain fatty acids, conjugated linolenic, cholesterol, phospholipids, and/or milk fat globule membrane proteins to the nutritional composition.

The milk fat globules may have an average diameter (volume-surface area average diameter) of at least about 2 μm. In some embodiments, the average diameter is in the range of from about 2 μm to about 13 μm. In other embodiments, the milk fat globules may range from about 2.5 μm to about 10 μm. Still in other embodiments, the milk fat globules may range in average diameter from about 3 μm to about 6 μm. The specific surface area of the globules is, in certain embodiments, less than 3.5 m²/g, and in other embodiments is between about 0.9 m²/g to about 3 m²/g. Without being bound by any particular theory, it is believed that milk fat globules of the aforementioned sizes are more accessible to lipases therefore leading to better digestion lipid digestion.

In some embodiments, the nutritional composition comprises at least one carbohydrate. Carbohydrate sources can be any used in the art, e.g., lactose, glucose, fructose, corn syrup solids, maltodextrins, sucrose, starch, rice syrup solids, and the like. The amount of the carbohydrate component in the nutritional composition typically can vary from between about 5 g and about 25 g/100 kcal. In some embodiments, the amount of carbohydrate is between about 6 g and about 22 g/100 kcal. In other embodiments, the amount of carbohydrate is between about 12 g and about 14 g/100 kcal. In some embodiments, corn syrup solids are preferred. Moreover, hydrolyzed, partially hydrolyzed, and/or extensively hydrolyzed carbohydrates may be desirable for inclusion in the nutritional composition due to their easy digestibility. Specifically, hydrolyzed carbohydrates are less likely to contain allergenic epitopes.

Non-limiting examples of carbohydrate materials suitable for use herein include hydrolyzed or intact, naturally or chemically modified, starches sourced from corn, tapioca, rice or potato, in waxy or non-waxy forms. Non-limiting examples of suitable carbohydrates include various hydrolyzed starches characterized as hydrolyzed cornstarch, maltodextrin, maltose, corn syrup, dextrose, corn syrup solids, glucose, and various other glucose polymers and combinations thereof. Non-limiting examples of other suitable carbohydrates include those often referred to as sucrose, lactose, fructose, high fructose corn syrup, indigestible oligosaccharides such as fructooligosaccharides and combinations thereof.

In one particular embodiment, the carbohydrate component of the nutritional composition is comprised of 100% lactose. In another embodiment, the carbohydrate component comprises between about 0% and 60% lactose. In another embodiment, the carbohydrate component comprises between about 15% and 55% lactose. In yet another embodiment, the carbohydrate component comprises between about 20% and 30% lactose. In these embodiments, the remaining source of carbohydrates may be any carbohydrate known in the art. In an embodiment, the carbohydrate component comprises about 25% lactose and about 75% corn syrup solids.

In some embodiments the nutritional composition comprises sialic acid. Sialic acids are a family of over 50 members of 9-carbon sugars, all of which are derivatives of neuroaminic acid. The predominant sialic acid family found in humans is from the N-acetylneuraminic acid sub-family. Sialic acids are found in milk, such as bovine and caprine. In mammals, neuronal cell membranes have the highest concentration of sialic acid compared to other body cell membranes. Sialic acid residues are also components of gangliosides.

If included in the nutritional composition, sialic acid may be present in an amount from about 0.5 mg/100 kcals to about 45 mg/100 kcal. In some embodiments sialic acid may be present in an amount from about 5 mg/100 kcals to about 30 mg/100 kcals. In still other embodiments, sialic acid may be present in an amount from about 10 mg/100 kcals to about 25 mg/100 kcals.

In some embodiments, the nutritional composition(s) of the disclosure may comprise at least one protein source. The protein source can be any used in the art, e.g., nonfat milk, whey protein, casein, soy protein, hydrolyzed protein, amino acids, and the like. Bovine milk protein sources useful in practicing the present disclosure include, but are not limited to, milk protein powders, milk protein concentrates, milk protein isolates, nonfat milk solids, nonfat milk, nonfat dry milk, whey protein, whey protein isolates, whey protein concentrates, sweet whey, acid whey, casein, acid casein, caseinate (e.g. sodium caseinate, sodium calcium caseinate, calcium caseinate) and any combinations thereof.

In some embodiments, the proteins of the nutritional composition are provided as intact proteins. In other embodiments, the proteins are provided as a combination of both intact proteins and hydrolyzed proteins. In certain embodiments, the proteins may be partially hydrolyzed or extensively hydrolyzed. In still other embodiments, the protein source comprises amino acids. In yet another embodiment, the protein source may be supplemented with glutamine-containing peptides. In another embodiment, the protein component comprises extensively hydrolyzed protein. In still another embodiment, the protein component of the nutritional composition consists essentially of extensively hydrolyzed protein in order to minimize the occurrence of food allergy. In yet another embodiment, the protein source may be supplemented with glutamine-containing peptides.

Accordingly, in some embodiments, the protein component of the nutritional composition comprises either partially or extensively hydrolyzed protein, such as protein from cow's milk. The hydrolyzed proteins may be treated with enzymes to break down some or most of the proteins that cause adverse symptoms with the goal of reducing allergic reactions, intolerance, and sensitization. Moreover, the proteins may be hydrolyzed by any method known in the art.

The terms “protein hydrolysates” or “hydrolyzed protein” are used interchangeably herein and refer to hydrolyzed proteins, wherein the degree of hydrolysis is may be from about 20% to about 80%, or from about 30% to about 80%, or even from about 40% to about 60%.

When a peptide bond in a protein is broken by enzymatic hydrolysis, one amino group is released for each peptide bond broken, causing an increase in amino nitrogen. It should be noted that even non-hydrolyzed protein would contain some exposed amino groups. Hydrolyzed proteins will also have a different molecular weight distribution than the non-hydrolyzed proteins from which they were formed. The functional and nutritional properties of hydrolyzed proteins can be affected by the different size peptides. A molecular weight profile is usually given by listing the percent by weight of particular ranges of molecular weight (in Daltons) fractions (e.g., 2,000 to 5,000 Daltons, greater than 5,000 Daltons).

In a particular embodiment, the nutritional composition is protein-free and contains free amino acids as a protein equivalent source. In this embodiment, the amino acids may comprise, but are not limited to, histidine, isoleucine, leucine, lysine, methionine, cysteine, phenylalanine, tyrosine, threonine, tryptophan, valine, alanine, arginine, asparagine, aspartic acid, glutamic acid, glutamine, glycine, proline, serine, carnitine, taurine and mixtures thereof. In some embodiments, the amino acids may be branched chain amino acids. In other embodiments, small amino acid peptides may be included as the protein component of the nutritional composition. Such small amino acid peptides may be naturally occurring or synthesized. The amount of free amino acids in the nutritional composition may vary from about 1 to about 5 g/100 kcal. In an embodiment, 100% of the free amino acids have a molecular weight of less than 500 Daltons. In this embodiment, the nutritional formulation may be hypoallergenic.

In an embodiment, the protein source comprises from about 40% to about 85% whey protein and from about 15% to about 60% casein.

In some embodiments, the nutritional composition comprises between about 1 g and about 7 g of a protein and/or protein equivalent source per 100 kcal. In other embodiments, the nutritional composition comprises between about 3.5 g and about 4.5 g of protein or protein equivalent per 100 kcal.

In some embodiments, the nutritional composition contains one or more prebiotics. Such prebiotics may be naturally-occurring, synthetic, or developed through the genetic manipulation of organisms and/or plants, whether such new source is now known or developed later. Prebiotics useful in the present disclosure may include oligosaccharides, polysaccharides, and other prebiotics that contain fructose, xylose, soya, galactose, glucose and mannose. More specifically, prebiotics useful in the present disclosure may include polydextrose, polydextrose powder, lactulose, lactosucrose, raffinose, gluco-oligosaccharide, inulin, fructo-oligosaccharide, isomalto-oligosaccharide, soybean oligosaccharides, lactosucrose, xylo-oligosaccharide, chito-oligosaccharide, manno-oligosaccharide, arabino-oligosaccharide, siallyl-oligosaccharide, fuco-oligosaccharide, galacto-oligosaccharide, and gentio-oligosaccharides.

In an embodiment, the total amount of prebiotics present in the nutritional composition may be from about 1.0 g/100 kcal to about 10.0 g/100 kcal of the composition. More preferably, the total amount of prebiotics present in the nutritional composition may be from about 2.0 g/100 kcal and about 8.0 g/100 kcal of the composition. At least 20% of the prebiotics can comprise a mixture of galacto-oligosaccharide and polydextrose. The amount of each of galacto-oligosaccharide and polydextrose in the nutritional composition may, in an embodiment, be within the range of from about 1.0 g/100 kcal to about 4.0 g/100 kcal.

The amount of galacto-oligosaccharide in the nutritional composition may, in an embodiment, be from about 0.1 g/100 kcal to about 1.0 g/100 kcal. In another embodiment, the amount of galacto-oligosaccharide in the nutritional composition may be from about 0.1 g/100 kcal to about 0.5 g/100 kcal. The amount of polydextrose in the nutritional composition may, in an embodiment, be within the range of from about 0.1 g/100 kcal to about 0.5 g/100 kcal. In another embodiment, the amount of polydextrose may be about 0.3 g/100 kcal. In a particular embodiment, galacto-oligosaccharide and polydextrose are supplemented into the nutritional composition in a total amount of about at least about 0.2 g/100 kcal and can be about 0.2 g/100 kcal to about 1.5 g/100 kcal.

In some embodiments, the particle sizes of the spore-forming probiotic, such as B. coagulans, and the prebiotic are the same or similar.

In some embodiments, the nutritional composition of the disclosure contains a source of long chain polyunsaturated fatty acids (LCPUFAs) that comprises docosahexaenoic acid (DHA). Other suitable LCPUFAs include, but are not limited to, α-linoleic acid, γ-linoleic acid, linoleic acid, linolenic acid, eicosapentaenoic acid (EPA) and arachidonic acid (ARA).

In one embodiment, the nutritional composition is supplemented with both DHA and ARA. In this embodiment, the weight ratio of ARA:DHA may be from about 1:3 to about 9:1. In one embodiment of the present disclosure, this ratio is from about 1:2 to about 4:1.

The amount of long chain polyunsaturated fatty acids in the nutritional composition is advantageously at least about 5 mg/100 kcal, and may vary from about 5 mg/100 kcal to about 100 mg/100 kcal, more preferably from about 10 mg/100 kcal to about 50 mg/100 kcal.

The nutritional composition may be supplemented with oils containing DHA and ARA using standard techniques known in the art. For example, DHA and ARA may be added to the composition by replacing an equivalent amount of an oil, such as high oleic sunflower oil, normally present in the composition. As another example, the oils containing DHA and ARA may be added to the composition by replacing an equivalent amount of the rest of the overall fat blend normally present in the composition without DHA and ARA.

If utilized, the source of DHA and ARA may be any source known in the art such as marine oil, fish oil, single cell oil, egg yolk lipid, and brain lipid. In some embodiments, the DHA and ARA are sourced from the single cell Martek oil, DHASCO@, or variations thereof. The DHA and ARA can be in natural form, provided that the remainder of the LCPUFA source does not result in any substantial deleterious effect on the infant. Alternatively, the DHA and ARA can be used in refined form.

In an embodiment of the present disclosure, sources of DHA and ARA are single cell oils as taught in U.S. Pat. Nos. 5,374,567; 5,550,156; and 5,397,591, the disclosures of which are incorporated herein in their entirety by reference. However, the present disclosure is not limited to only such oils. [0078]1 Conveniently, commercially available infant formula can be used. For example, Enfalac, Enfamil®, Enfamil® Premature Formula, Enfamil®) with Iron, Lactofree®, Nutramigen®, Pregestimil®), and ProSobee® (available from Mead Johnson Nutrition Company, Evansville, Ind., U.S.A.) may be supplemented with suitable levels of spore-forming probiotic and used in practice of the method of the disclosure.

In embodiments providing a children's nutritional product, one or more vitamins and/or minerals may be added in amounts sufficient to supply the daily nutritional requirements of children between one and thirteen years old. It is to be understood by one of ordinary skill in the art that vitamin and mineral requirements will vary for children between the ages of one and thirteen years. Thus, the embodiments are not intended to limit the nutritional composition to a particular age group but, rather, to provide a range applicable to children between the one and thirteen years old.

In embodiments providing a nutritional composition for a child, the composition may optionally include, but is not limited to, one or more of the following vitamins or derivations thereof: vitamin B₁ (thiamin, thiamin pyrophosphate, TPP, thiamin triphosphate, TTP, thiamin hydrochloride, thiamin mononitrate), vitamin B₂ (riboflavin, flavin mononucleotide, FMN, flavin adenine dinucleotide, FAD, lactoflavin, ovoflavin), vitamin B₃ (niacin, nicotinic acid, nicotinamide, niacinamide, nicotinamide adenine dinucleotide, NAD, nicotinic acid mononucleotide, NicMN, pyridine-3-carboxylic acid), vitamin B₃-precursor tryptophan, vitamin B₆ (pyridoxine, pyridoxal, pyridoxamine, pyridoxine hydrochloride), pantothenic acid (pantothenate, panthenol), folate (folic acid, folacin, pteroylglutamic acid), vitamin B₁₂ (cobalamin, methylcobalamin, deoxyadenosylcobalamin, cyanocobalamin, hydroxycobalamin, adenosylcobalamin), biotin, vitamin C (ascorbic acid), vitamin A (retinol, retinyl acetate, retinyl palmitate, retinyl esters with other long-chain fatty acids, retinal, retinoic acid, retinol esters), vitamin D (calciferol, cholecalciferol, vitamin D₃, 1,25,-dihydroxyvitamin D), vitamin E (α-tocopherol, α-tocopherol acetate, α-tocopherol succinate, α-tocopherol nicotinate, α-tocopherol), vitamin K (vitamin K, phylloquinone, naphthoquinone, vitamin K₂, menaquinone-7, vitamin K₃, menaquinone-4, menadione, menaquinone-8, menaquinone-8H, menaquinone-9, menaquinone-9H, menaquinone-10, menaquinone-11, menaquinone-12, menaquinone-13), choline, inositol, 3-carotene and any combinations thereof.

In embodiments providing a children's nutritional product, the composition may optionally include, but is not limited to, one or more of the following minerals or derivations thereof: boron, calcium, calcium acetate, calcium gluconate, calcium chloride, calcium lactate, calcium phosphate, calcium sulfate, chloride, chromium, chromium chloride, chromium picolinate, copper, copper sulfate, copper gluconate, cupric sulfate, fluoride, iron, carbonyl iron, ferric iron, ferrous fumarate, ferric orthophosphate, iron trituration, polysaccharide iron, iodide, iodine, magnesium, magnesium carbonate, magnesium hydroxide, magnesium oxide, magnesium stearate, magnesium sulfate, manganese, molybdenum, phosphorus, potassium, potassium phosphate, potassium iodide, potassium chloride, potassium acetate, selenium, sulfur, sodium, docusate sodium, sodium chloride, sodium selenate, sodium molybdate, zinc, zinc oxide, zinc sulfate and mixtures thereof. Non-limiting exemplary derivatives of mineral compounds include salts, alkaline salts, esters and chelates of any mineral compound.

The minerals can be added to children's nutritional compositions in the form of salts such as calcium phosphate, calcium glycerol phosphate, sodium citrate, potassium chloride, potassium phosphate, magnesium phosphate, ferrous sulfate, zinc sulfate, cupric sulfate, manganese sulfate, and sodium selenite. Additional vitamins and minerals can be added as known within the art.

In an embodiment, the children's nutritional composition may contain between about 10 and about 50% of the maximum dietary recommendation for any given country, or between about 10 and about 50% of the average dietary recommendation for a group of countries, per serving of vitamins A, C, and E, zinc, iron, iodine, selenium, and choline. In another embodiment, the children's nutritional composition may supply about 10-30% of the maximum dietary recommendation for any given country, or about 10-30% of the average dietary recommendation for a group of countries, per serving of B-vitamins. In yet another embodiment, the levels of vitamin D, calcium, magnesium, phosphorus, and potassium in the children's nutritional product may correspond with the average levels found in milk. In other embodiments, other nutrients in the children's nutritional composition may be present at about 20% of the maximum dietary recommendation for any given country, or about 20% of the average dietary recommendation for a group of countries, per serving.

The children's nutritional composition of the present disclosure may optionally include one or more of the following flavoring agents, including, but not limited to, flavored extracts, volatile oils, cocoa or chocolate flavorings, peanut butter flavoring, cookie crumbs, vanilla or any commercially available flavoring. Examples of useful flavorings include, but are not limited to, pure anise extract, imitation banana extract, imitation cherry extract, chocolate extract, pure lemon extract, pure orange extract, pure peppermint extract, honey, imitation pineapple extract, imitation rum extract, imitation strawberry extract, or vanilla extract; or volatile oils, such as balm oil, bay oil, bergamot oil, cedarwood oil, cherry oil, cinnamon oil, clove oil, or peppermint oil; peanut butter, chocolate flavoring, vanilla cookie crumb, butterscotch, toffee, and mixtures thereof. The amounts of flavoring agent can vary greatly depending upon the flavoring agent used. The type and amount of flavoring agent can be selected as is known in the art.

The nutritional compositions of the present disclosure may optionally include one or more emulsifiers that may be added for stability of the final product. Examples of suitable emulsifiers include, but are not limited to, lecithin (e.g., from egg or soy), alpha lactalbumin and/or mono- and di-glycerides, and mixtures thereof. Other emulsifiers are readily apparent to the skilled artisan and selection of suitable emulsifier(s) will depend, in part, upon the formulation and final product.

The nutritional compositions of the present disclosure may optionally include one or more preservatives that may also be added to extend product shelf life. Suitable preservatives include, but are not limited to, potassium sorbate, sodium sorbate, potassium benzoate, sodium benzoate, calcium disodium EDTA, and mixtures thereof.

The nutritional compositions of the present disclosure may optionally include one or more stabilizers. Suitable stabilizers for use in practicing the nutritional composition of the present disclosure include, but are not limited to, gum arabic, gum ghatti, gum karaya, gum tragacanth, agar, furcellaran, guar gum, gellan gum, locust bean gum, pectin, low methoxyl pectin, gelatin, microcrystalline cellulose, CMC (sodium carboxymethylcellulose), methylcellulose hydroxypropyl methyl cellulose, hydroxypropyl cellulose, DATEM (diacetyl tartaric acid esters of mono- and diglycerides), dextran, carrageenans, and mixtures thereof.

The following examples are provided to illustrate some embodiments of the nutritional composition of the present disclosure but should not be interpreted as any limitation thereon. Other embodiments within the scope of the claims herein will be apparent to one skilled in the art from the consideration of the specification or practice of the nutritional composition or methods disclosed herein. It is intended that the specification, together with the example, be considered to be exemplary only, with the scope and spirit of the disclosure being indicated by the claims which follow the example.

### Examples

### Example 1

### Milk Protein Based Formula

| Nutrient | Unit | Per 100 g |
|---|---|---|
| Protein | g | 10.6 |
| Fat | g | 27 |
| Linoleic Acid | mg | 4100 |
| Alpha-Linolenic Acid | mg | 360 |
| Docosahexaenoic Acid | mg | 90 |
| (DHA) | | |
| Arachidonic Acid (ARA) | mg | 180 |
| Carbohydrates | g | 57 |
| GOS | g | 1.56 |
| Polydextrose | g | 1.56 |
| Vitamin A | μg_RE | 420 |
| Vitamin D | μg | 7.8 |
| Vitamin E | mg_A_TE | 6.4 |
| Vitamin K | μg | 36 |
| Thiamin | μg | 430 |
| Riboflavin | μg | 860 |
| Vitamin B6 | μg | 300 |
| Vitamin B12 | μg | 1.56 |
| Niacin | μg | 3300 |
| Folic Acid | μg | 91 |
| Pantothenic Acid | μg | 2900 |
| Biotin | μg | 13.6 |
| Vitamin C | mg | 91 |
| Sodium | mg | 141 |
| Potassium | mg | 560 |
| Chloride | mg | 330 |
| Calcium | mg | 400 |
| Phosphorus | mg | 240 |
| Magnesium | mg | 40 |
| Iodine | μg | 86 |
| Iron | mg | 5 |
| Copper | μg | 330 |
| Zinc | mg | 4 |
| Manganese | μg | 91 |
| Selenium | μg | 13.6 |
| Choline | mg | 121 |
| Inositol | mg | 43 |
| Carnitine | mg | 10.1 |
| Taurine | mg | 30 |
| Total Nucleotides | mg | 15.4 |
| B Coagulans | g | 0.35 |

### Example 2

### Milk Protein Based Formula

| | | Per |
|---|---|---|
| Nutrient | Unit | 100 g |
| Protein | g | 14.9 |
| Fat | g | 18.5 |
| Linoleic Acid | mg | 2900 |
| Alpha-Linolenic Acid | mg | 250 |
| Docosahexaenoic Acid | mg | 78 |
| (DHA) | | |
| Arachidonic Acid (ARA) | mg | 156 |
| Carbohydrates | g | 58 |
| GOS | g | 1.58 |
| Polydextrose | g | 1.58 |
| Vitamin A | μg_RE | 410 |
| Vitamin D | μg | 6.3 |
| Vitamin E | mg_A_TE | 5.1 |
| Vitamin K | μg | 36 |
| Thiamin | μg | 360 |
| Riboflavin | μg | 900 |
| Vitamin B6 | μg | 320 |
| Vitamin B12 | μg | 2.3 |
| Niacin | μg | 3200 |
| Folic Acid | μg | 72 |
| Pantothenic Acid | μg | 2900 |
| Biotin | μg | 13.5 |
| Vitamin C | mg | 90 |
| Sodium | mg | 210 |
| Potassium | mg | 680 |
| Chloride | mg | 420 |
| Calcium | mg | 500 |
| Phosphorus | mg | 290 |
| Magnesium | mg | 43 |
| Iodine | μg | 99 |
| Iron | mg | 5.6 |
| Copper | μg | 310 |
| Zinc | mg | 3.4 |
| Manganese | μg | 80 |
| Selenium | μg | 11.3 |
| Choline | mg | 108 |
| Inositol | mg | 32 |
| Taurine | mg | 19.4 |
| Total Nucleotides | mg | 18 |
| B Coagulans | g | 0.35 |

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged in whole or in part. For example, while methods for the production of a commercially sterile liquid nutritional supplement made according to those methods have been exemplified, other uses are contemplated. Therefore, the spirit and scope of the appended claims should not be limited to the description of the versions contained therein.

What is claimed is:

1. A nutritional composition for a pediatric subject, comprising:
a fat;
a carbohydrate;
a protein or protein equivalent source source; and
a spore-forming probiotic.

2. The nutritional composition of claim 1, wherein the spore-forming probiotic comprises Bacillus coagulans.

3. The nutritional composition of claim 2, wherein the nutritional composition comprises at least 1×10⁶ cfu Bacillus coagulans per 100 kcal nutritional composition.

4. The nutritional composition of claim 3, wherein the nutritional composition comprises Bacillus coagulans in the range of about 1×10⁶ cfu to about 1×10⁹ cfu per 100 kcal nutritional composition.

5. The nutritional composition of claim 1, further comprising a prebiotic.

6. The nutritional composition of claim 5, wherein the prebiotic comprises polydextrose and galacto-oligosaccharide.

7. The nutritional composition of claim 1, further comprising at least one long chain polyunsaturated fatty acid.

8. The nutritional composition of claim 7, wherein the long chain polyunsaturated fatty acid is selected from the group consisting of docosahexaenoic acid, arachidonic acid, or combinations thereof.

9. The nutritional composition of claim 8, wherein the ratio of arachidonic acid:docosahexaenoic acid by weight is from about 1:3 to about 9:1.

10. The nutritional composition of claim 1, wherein the nutritional composition is an infant formula.

11. A method for enhancing immune function of a pediatric subject by administering to the pediatric subject a nutritional composition, comprising:
a fat;
a carbohydrate;
a protein or protein equivalent source;
a prebiotic; and
a spore-forming probiotic,
wherein the administration of the nutritional composition enhances the immune function of the pediatric subject.

12. The method of claim 11, wherein the spore-forming probiotic comprises Bacillus coagulans.

13. The method of claim 12, wherein the nutritional composition comprises at least 1×10⁶ cfu Bacillus coagulans per 100 kcal nutritional composition.

14. The method of claim 13, wherein the nutritional composition comprises Bacillus coagulans in the range of about 1×10⁶ cfu to about 1×10 dcfu per 100 kcal nutritional composition.

15. The method of claim 11, further comprising a prebiotic, wherein the prebiotic comprises polydextrose and galacto-oligosaccharide.

16. The method of claim 11, further comprising at least one long chain polyunsaturated fatty acid selected from the group consisting of docosahexaenoic acid, arachidonic acid, or combinations thereof.

17. The method of claim 11, wherein the nutritional composition is an infant formula.
